(19) United States
(12) Patent Application Publication
(10) Pub. No.: US 2011/0216036 A1
(43) Pub. Date: Sep. 8, 2011

(54) MULTI-TOUCH DETECTING METHOD FOR TOUCH SCREENS

(76) Inventors: JK Zhang, Shenzhen (CN); Michael Mo, Shenzhen (CN)

(21) Appl. No.: 13/039,783

(22) Filed: Mar. 3, 2011

(30) Foreign Application Priority Data
Mar. 3, 2010 (CN) CN 201010117999.X

(51) Int. Cl. G06F 3/045

(52) U.S. Cl. 345/174

(57) ABSTRACT

A multi-touch detecting method for touch screens relates to an input device for converting data to be processed so that a computer can process the data, particularly to a digital converter with a characteristic converting mode. The digital converter comprises a touch screen, a capacitance induction circuit, a capacitance data processing module and a system host, wherein the touch screen comprises M*N mutual capacitance arrays formed from M transversal electrodes and N longitudinal electrodes which are orthogonal; the capacitance induction circuit continuously detects all capacitances of the touch screen in real time to obtain one frame of real-time two-dimensional arrays corresponding to the capacitances; the capacitance induction circuit takes the original capacitance of the touch screen without touch as a flat, takes an area touched effectively as a “depression”, judges the “depression”, separates the “depression” into “equivalent depressions” formed by touching one or multiple points effectively and calculates the coordinate of the central position of the “equivalent depressions”. The multi-touch detecting method for touch screens has the advantages of high touch sensing accuracy and accurate touch point calculation and conforms to requirements of multipoint sensing.

### TECHNICAL FIELD

The present invention relates to a multi-touch detecting method for input devices converting data to be processed so that a computer can process the data, particularly digital converters with a characteristic converting mode, such as touch screens or touch pads, specifically touch screens with a capacitive converting mode.

### BACKGROUND ART

Touch screens can be realized in various modes, and popularly include resistive touch screens, capacitive touch screens, infrared surface touch screens and the like, wherein the infrared surface touch screens are the most popular because of high light transmittance, abrasion resistance, environmental change resistance (temperature, humidity, etc.), long life and high and complex functions (such as multi-touch).

U.S. Pat. No. 5,825,352 discloses a capacitive multi-touch technology. The technology uses a peak detecting method to detect touch on X axis and Y axis on the touch screen, as shown in FIG. 1. When two fingers touch the surface of the touch screen, capacitances on the X axis scatter in a shape of waves shown in FIG. 2, two peaks are found by searching, and then the two peaks can be regarded as potential touch centers. To increase the accuracy of touch judgment, the capacitance increase at a peak must be greater than a threshold; the Y axis and the X axis are treated similarly. Thus, two touch points can be identified by respectively detecting peaks and judging thresholds for the X axis and the Y axis. The data processing in the type of touch value increase is carried out in the X axis and the Y axis.

Chinese patent CN200710188791.5 discloses a capacitive detecting method for ITO touch panels. This method uses two groups of multiple lines of induction in the first direction and the second direction which are orthogonal, and multiple induction values generated in the first direction and the second direction by multi-touch are used to determine relative positions in this direction and another direction.

The patents above both reflect two-dimensional conditions by using unidimensional processing twice, and have low accuracy, particularly inaccurate calculation of touch points of each finger when multiple fingers are close; in addition, the determination of touch centers by peaks on the X axis or Y axis (the first direction and the second direction) only is not accurate enough, values around the peaks are not used, and the accuracy of touch sensing is low when capacitances on the touch screen scatter loosely.

### Invention Contents

The technical problem the present invention aims to settle is to avoid the defects of the prior art to provide a multi-touch detecting method for touch screens, and the detecting method has high touch sensing accuracy and accurate touch point calculation and conforms to requirements of multipoint sensing.

The invention adopts the technical solution to solve the technical problems: on the mutual capacitance touch screen, use the two-dimensional detecting method to detect the changes in capacitance generated by touching the touch screen with fingers, and judge whether effective touch occurs, calculate and output the corresponding coordinate of the equivalent area touched effectively through the changes in capacitance. The invention regards a mutual capacitance array before touch as a flat and regards an area touched effectively as a “depression”.

The invention adopts a multi-touch detecting method for touch screens, namely the mutual capacitance touch screen mentioned in the Chinese Patent Application submitted by this applicant of which the application No. is 200810171009.3 and the title is “A MUTUAL CAPACITANCE TOUCH SCREEN AND A COMBINED-TYPE MUTUAL CAPACITANCE TOUCH SCREEN”, and relates to a system comprising the mutual capacitance touch screen, a capacitance induction circuit, a capacitance data processing module and a host. Transversal electrodes are connected by a driving line, longitudinal electrodes are connected by a line of induction, and each driving line is orthogonal with each line of induction to form a mutual capacitance to be detected. The touch screen comprises M*N mutual capacitance arrays formed from M driving lines and N lines of induction.

A multi-touch detecting method for touch screens relates to a system comprising the touch screen, a capacitance induction circuit, a capacitance data processing module and a host, wherein the touch screen comprises M*N mutual capacitance arrays formed from M transversal electrodes and N longitudinal electrodes which are orthogonal. The method comprises the following steps:

A. The capacitance induction circuit detects all capacitances of the touch screen to obtain M*N real-time two-dimensional values corresponding to the capacitances, and a two-dimensional array formed from these values is used as the data source for detection of touch points. The capacitance of a touched area is smaller than that of an untouched area, when the original value of the whole untouched area is regarded as a flat, a concave can appear in the area touched effectively, and please regard the concave as a “depression”.

B. Judge whether effective touch occurs or not, namely, to find “depressions” in accordance with the two-dimensional array obtained in Step A; if not, return to Step A; or else, do Step C;

C. Separate the “depression” touched effectively;

E. Determine the equivalent “depression” of the “depression” touched effectively;

F. Calculate and output the coordinate corresponding to the equivalent “depression” of the “depression” touched effectively, and return to Step A.

In Step A, the two-dimensional value corresponding to the capacitance can be the two-dimensional value of an actual capacitance converted or not.

In Step B, the method to judge effective touch, namely “depression” existence in the whole area is: judging whether groups in which some values are smaller than a touch threshold exist in the two-dimensional array obtained in Step A, wherein the area formed by these groups of values is a “depression” with low middle and rising circumference. In accordance with the conditions above, “depressions” can be separated.

When only one touch point exists, one “depression” appears; when multi-touch occurs, many “depressions” appear, and these “depressions” must be unified into equivalent “depressions” of the “depression”; the equivalent “depression” of the “depression” touched effectively in Step C includes all points of groups in which some values are smaller than a touch threshold, and the area formed by points on the lines connecting all the points. The coordinate corresponding to the equivalent “depression” described in Step E can be the central coordinate of the “depression” graphic, and can be calculated from the formula as follows:

$$\{ \begin{matrix}{X}_{M} = \frac{{\sum }_{i} ( {x}_{i} * Δ {C}_{i} )}{{\sum }_{i} Δ {C}_{i}} \\ {Y}_{M} = \frac{{\sum }_{i} ( {y}_{i} * Δ {C}_{i} )}{{\sum }_{i} Δ {C}_{i}} ,\end{matrix}$$

in which i represents the No. of capacitance nodes in one “depression”; xᵢ and yᵢ respectively represent the abscissa/ordinate of the iₜₕ node; Cᵢ represents the capacitance corresponding to the iₜₕ node; and ΔCᵢ represents change in capacitance corresponding to the iₜₕ node.

The capacitance induction circuit continuously detects all capacitances of the touch screen to obtain M*N real-time two-dimensional values corresponding to the capacitances, and a two-dimensional array formed from these values is used as the data source for detection of touch points. The capacitance of a touched area is smaller than that of an untouched area, when the original value of the whole touched area is regarded as a flat, a concave can appear in the area touched effectively, and please regard the concave as a “depression”.

It is as if a camera takes pictures of the touch screen repeatedly. Every capacitance picture is a two-dimensional array, when a finger touches the surface of the touch screen, the capacitance of the area covered by the finger decreases, and the changes in capacitances are reflected in the capacitance picture. After the capacitance induction circuit obtains one frame of new capacitance image, data of the capacitance image is used as the new data source for detection of touch points. If a two-dimensional capacitance picture is regarded as a terrain elevation map, an effectively touched area which is touched with one finger is a concave “depression”, and multiple concave “depressions” can appear on the capacitance picture for multi-touch of multiple fingers. The area below the finger center has the greatest change in capacitance, and is the center of a “depression”. Separate all “depressions” touched effectively from the capacitance image in accordance with the criteria: the capacitance of points in single “depression” is smaller than the capacitance (0) of the flat, and points in multiple “depressions” and the area formed from points on lines connecting these points are regarded as the “equivalent depression” for the touch. If “depressions” conforming to the criteria do not exist, judge that no effective touch exists in the frame; or else, calculate the “equivalent depression” for the touch, and the coordinate corresponding to the “equivalent depression”.

The coordinate corresponding to the “equivalent depression” can be the coordinate of the central position, and can be calculated from the formula as follows:

$$\{ \begin{matrix}{X}_{M} = \frac{{\sum }_{i} ( {x}_{i} * Δ {C}_{i} )}{{\sum }_{i} Δ {C}_{i}} \\ {Y}_{M} = \frac{{\sum }_{i} ( {y}_{i} * Δ {C}_{i} )}{{\sum }_{i} Δ {C}_{i}} ,\end{matrix}$$

in which i represents the No. of capacitance nodes in one depression; xᵢ and yᵢ respectively represent the abscissa/ordinate of the iₜₕ node; Cᵢ represents the capacitance corresponding to the iₜₕ node; and ΔCᵢ represents change in capacitance corresponding to the iₜₕ node.

For convenience, the two-dimensional value corresponding to the capacitance can be the two-dimensional value of actual capacitance converted or not. The actual capacitance can be converted to the value corresponding to capacitance, and the value can be the product of the actual capacitance and a coefficient, the difference between the actual capacitance and a threshold (0) or the product of the difference and a coefficient.

The present invention has the advantages that the use of a two-dimensional array detecting method can reflect the objective condition of changes in capacitance generated by touching the touch screen with fingers, so that touch judgment and calculation of touch centers are more accurate; the two-dimensional array detecting method can effectively detect changes in capacitance in atypical conditions, for example, two touch points are close together, irregular objects except fingers touch the touch screen, etc.

### DESCRIPTION OF FIGURES

The invention is described hereinafter with reference to the following drawings, in which:

FIG. 1 shows a schematic diagram of touching the touch screen with fingers;

FIG. 2 shows a diagram of capacitances scattered on one axis in the unidimensional processing technology when two fingers touch the surface of the touch screen;

FIG. 3 shows a system diagram of methods related in the invention;

FIG. 4 shows a mutual capacitance schematic diagram of the mutual capacitance touch screen of the system related in the invention;

FIG. 5 (a) shows a capacitance schematic diagram before touch;

FIG. 5 (b) shows a capacitance schematic diagram with two touch points;

FIG. 6 shows the method flow diagram of the first embodiment of the invention;

FIG. 7 shows the method flow diagram of the second embodiment of the invention;

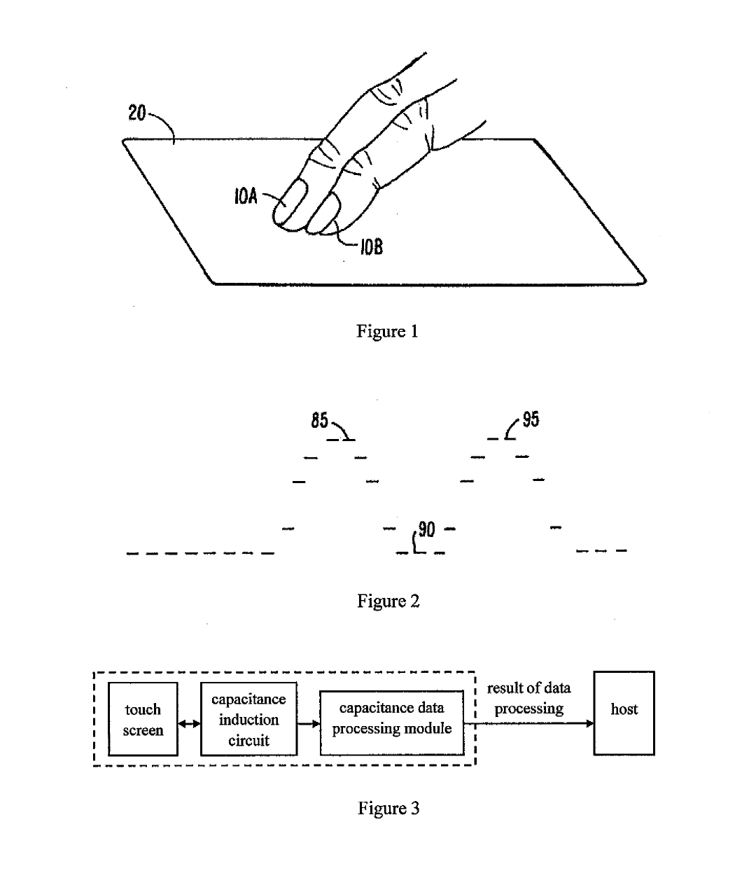

Wherein, 10A and 10B represent fingers, 20 represents the touch screen, 210 and 211 represent transversal electrodes, and 310 and 311 represent longitudinal electrodes.

### MODE OF CARRYING OUT THE INVENTION

The invention is further described hereinafter with reference to embodiments shown in the following drawings.

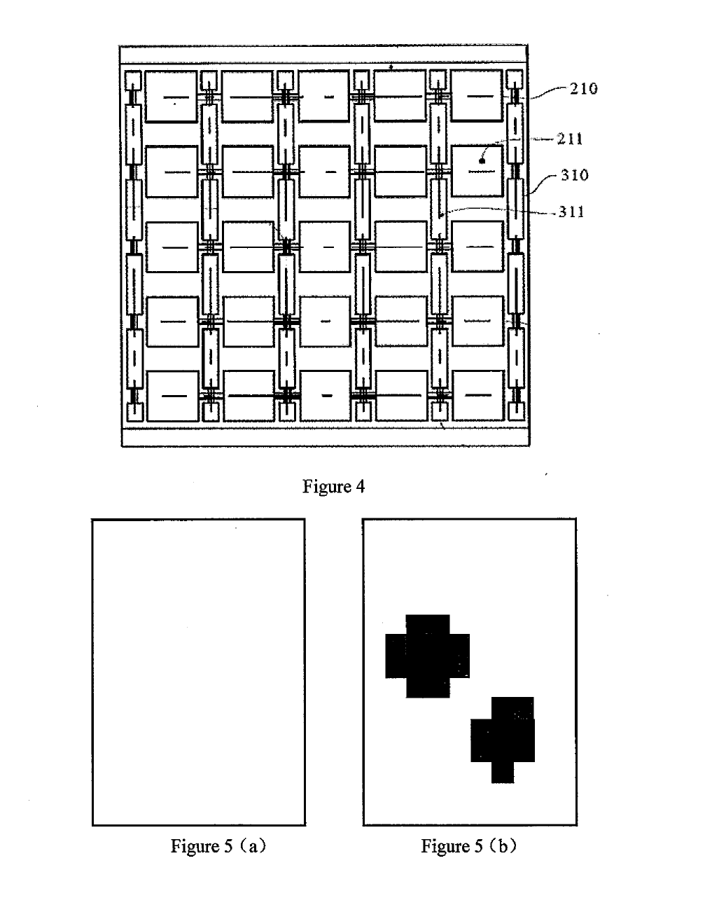

With reference to FIG. 3, FIG. 4 and FIG. 5, the detection system in the detecting method comprises four parts: the touch screen, the capacitance induction circuit, the capacitance data processing module and the host, wherein the touch screen is a mutual capacitance touch screen; transversal electrodes 210, 211 and the like are connected by a driving line; longitudinal electrodes 310, 311 and the like are connected by a line of induction; each driving line is orthogonal with each line of induction to form a mutual capacitance to be detected; and the touch screen comprises M*N mutual capacitance arrays formed from M driving lines and N lines of induction. The capacitance induction circuit can continuously detect all capacitances of the touch screen in real time to obtain M*N real-time data corresponding to the capacitances, as if a camera takes pictures of the touch screen repeatedly. Each capacitance picture is a two-dimensional array; when a finger touches the surface of the touch screen, the capacitance of an area covered by the finger decreases; and the changes in capacitances are reflected in the capacitance picture. If the two-dimensional capacitance picture is regarded as a terrain elevation map, a “depression” appears in the area touched by the finger; for multi-touch, many “depressions” appear on the map; and as shown in FIG. 5(b), the more dark the color is, the smaller the value is.

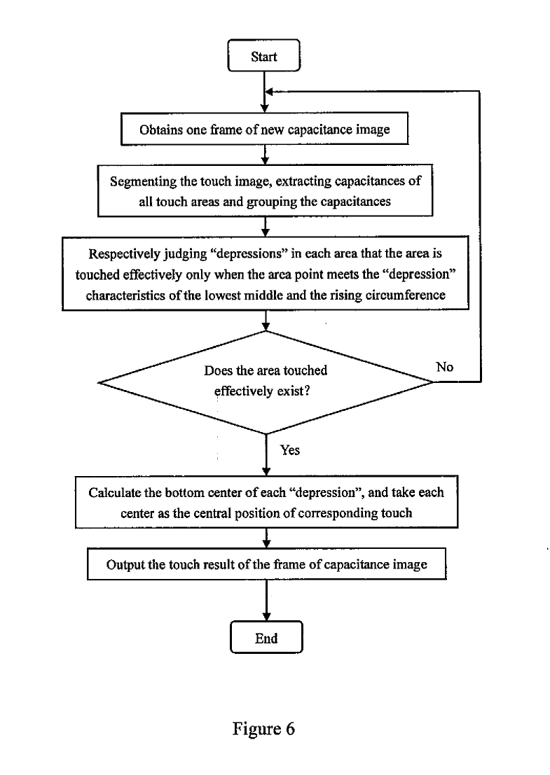

As shown in FIG. 6, in the first embodiment of the invention, the capacitance described in Step A is the actual capacitance. After the touch screen detection circuit obtains one frame of new capacitance image, the capacitance of the capacitance image is used as the new data source for detection of touch points.

In the first embodiment of the invention, Step B comprises: segmenting the touch image, extracting capacitances of all touch areas and grouping the capacitances in accordance with the latest frame of capacitance images obtained in Step A, namely the new data source for detection of touch points; and then, respectively judging “depressions” in each area that the area is touched effectively only when the area point meets the “depression” characteristics of the lowest middle and the rising circumference. In Step B, the method to judge effective touch, namely “depression” existence in the whole area is: judging whether groups in which some values are smaller than a touch threshold exist in the M*N two-dimensional arrays obtained in Step A, wherein the area formed by these groups of values is a “depression” with low middle and rising circumference. Step B also comprises a flow for judging the effective touch, namely that through the flow for judging the effective touch, the subsequent data processing proceeds if the area touched effectively exists; if the area touched effectively does not exist, return to Step A to obtain the latest frame of capacitance images again; or else, judge that no touch event occurs on the touch screen.

In the first embodiment of the invention, Step C and Step B are carried out in combination; as shown in FIG. 6, in the process of judging the area touched effectively, the image segmentation is also the process of separating an area prejudged as a “depression”, but the subsequent judgment is required to judge whether the area prejudged as “depression” is the “depression” which conforms to preset conditions and can be used as effective touch or not. If the area prejudged as “depression” is judged as the “depression” touched effectively, the process of separating the “depression” touched effectively in Step C is simultaneously finished.

In the first embodiment of the invention, as shown in FIG. 6, after judging the existence of the area touched effectively, do Step E to determine the equivalent “depression” of the “depression” touched effectively, particularly to calculate the bottom center of each “depression”, and take each center as the central position of corresponding touch. The central position is the central coordinate of the “depression” and also the central coordinate of the position touched. The coordinate corresponding to the equivalent “depression” of the “depression” touched effectively in Step E is the central coordinate of the “depression”, and is calculated from the formula as follows:

$$\{ \begin{matrix}{X}_{M} = \frac{{\sum }_{i} ( {x}_{i} * Δ {C}_{i} )}{{\sum }_{i} Δ {C}_{i}} \\ {Y}_{M} = \frac{{\sum }_{i} ( {y}_{i} * Δ {C}_{i} )}{{\sum }_{i} Δ {C}_{i}} ,\end{matrix}$$

in which i represents the No. of capacitance nodes in one “depression”; xᵢ and yᵢ respectively represent the abscissa/ordinate of the iₜₕ node; Cᵢ represents the capacitance corresponding to the iₜₕ node; and ΔCᵢ represents change in capacitance corresponding to the iₜₕ node.

In the first embodiment of the invention, as shown in FIG. 6, after the calculation of the central coordinate of the equivalent “depression”, output the touch result of the frame of capacitance image, namely respective central coordinates of touched positions.

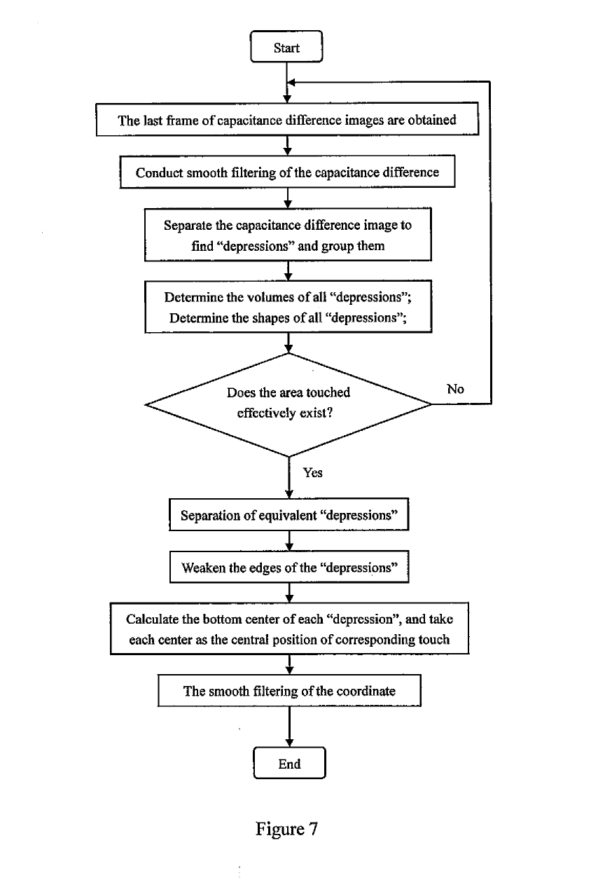

In the second embodiment of the invention, as shown in FIG. 7, M*N two-dimensional values corresponding to capacitances in Step A include difference between each capacitance and untouched “0” defined by a “capacitance difference image method”, namely the last frame of capacitance difference images. Particularly, before using the touch screen, the system calibrates the capacitance arrays on the touch screen. The calibration has the purpose of recording all capacitances before touch on the surface of the touch screen in good condition. The capacitance is used as a threshold (0). In normal operation, take the difference between the capacitance and 0 to obtain the capacitance difference image of which the processing is easier than that of the original capacitance image. For the difference image, the values of all nodes approximate 0 if no touch occurs; when touch occurs, several “depression” values approximating 0 are generated; and the judgment of “depressions” in accordance with the flat of 0 is more convenient.

In the second embodiment of the invention, as shown in FIG. 7, after the last frame of capacitance difference images are obtained, conduct smooth filtering of the capacitance difference to make calculation results smooth, and thus the filtering of capacitance difference is finished. Particularly, each value in the capacitance difference arrays is processed through the smooth low-pass filtering of time by a Butterworth first-order filter. For the capacitance difference image filtered by the method of the first embodiment, separate “depressions”, and then determine the volume and the shape of each “depression” separated.

In the second embodiment of the invention, as shown in FIG. 7, after the filtering of capacitance difference, separate the capacitance difference image to find “depressions” and group them. Then, determine the volumes and the shapes of all “depressions”, and judge whether the “depressions” are areas which are touched effectively and conform to requirements or not through the volumes and shapes. If the area touched effectively does not exist, return to Step A to obtain the last frame of capacitance difference images again; or else, do the subsequent data processing.

The volume of the “depression” can be calculated from the formula

$$V = {\sum }_{i} {C}_{i} .$$

The shape of a “depression” can be judged in two ways: first, judging the concave degree of the “depression”: the concave degree coefficient is calculated from the formula

$$D = \frac{\sum Valley}{V} ,$$

in which Valley represents the sum of values of the concave valley and the circumference thereof, V represents the volume of the “depression”, the greater the value of the concave degree coefficient D is, the smaller the concave degree is, the smaller the D is, the greater the concave degree is, the “depression” formed by touching the touch screen with a finger is more steep, and therefore D is smaller than a concave threshold D₀; second, judging the graded distribution in the “depression”: the gradient in the correct “depression” changes smoothly; the edge gradient of the “depression” is smaller and increases by degrees; the gradient close to the valley decreases by degrees; and the gradient of the valley approximates 0. The “depression” which meets concave degree and graded distribution is the area touched effectively.

In the second embodiment of the invention, as shown in FIG. 7, when the “depression” is judged to be accumulated in the area touched effectively, the separation of equivalent “depressions” is required. When the positions of multiple fingers are close, communicated “depressions” will appear, with the characteristic of multiple valleys in the “depressions”. Then, judge the ridge between two valleys; if the height of the ridge approximates that of the adjacent valley, combine the two valleys belonging to one touch; if the height of the ridge quite differs from that of the adjacent valley, separate the two valleys to represent two touch areas.

In the second embodiment of the invention, as shown in FIG. 7, after separation of equivalent “depressions”, weaken the edges of the “depressions”; then calculate the bottom center of each “depression”, and take each center as the central position of the corresponding touch. The bottom center of the “depression” is the coordinate of the bottom central position. The process of weakening the edges of the “depressions” is usually carried out simultaneously in the process of calculating the bottom centers of the “depressions”. When the centers of the “depressions” are calculated, noises from the edges of the “depressions” greatly affect the centers, and therefore the edges of the “depression” are weakened for obtaining more stable touch centers. In the embodiment of weakening the edges, compare and judge nodes at the edges of the “depressions” touched effectively; if the change in capacitance of the nodes is smaller than a change threshold, and multiply the change in capacitance and a coefficient which is greater than 0 and smaller than 1 to weak the edges.

In the second embodiment of the invention, as shown in FIG. 7, after the coordinate of the center of the “depression” is obtained, finish the smooth filtering flow of the coordinate for smoothness, and particularly, finish the smooth filtering of the coordinate in time. In an embodiment, for obtaining the filtering effect conforming to the actual condition, when the position touched with the finger changes slightly in two successive frames of data, the stability is required as far as possible, the low-pass filtering coefficient is great, and thus the viscous effect of the coordinate is obvious; when the position touched with the finger changes greatly, the low-pass filtering coefficient is small, and thus the coordinate calculation can keep pace with the finger change as quickly as possible.

Of course, the output of the touch coordinate is also required after the smooth filtering, of the touch coordinate.

1. A multi-touch detecting method for touch screens relates to a system comprising the touch screen, a capacitance induction circuit, a capacitance data processing module and a host, wherein the touch screen comprises M*N mutual capacitance arrays formed from M transversal electrodes and N longitudinal electrodes which are orthogonal; The method comprises the following steps:
A. The capacitance induction circuit detects all capacitance of the touch screen to obtain M*N real-time two-dimensional values corresponding to capacitances, and a two-dimensional array formed from these values is used as the data source for detection of touch points; The capacitances of a touched areas is smaller than that of an untouched area; if the original value of the whole untouched area is regarded as a flat, a concave can appear in the area touched effectively, and please regard the concave as a “depression”;
B. Judge whether effective touch occurs or not, namely, to find “depressions” in accordance with the two-dimensional array obtained in Step A, if not, return to Step A; or else, do Step C;
C. Separate the “depression” touched effectively;
E. Determine the equivalent “depression” of the “depression” touched effectively;
F. Calculate and output the coordinate corresponding to the equivalent “depression” of the “depression” touched effectively, and return to Step A.

2. The multi-touch detecting method for touch screens according to claim 1 is characterized in that:
In Step A, the two-dimensional value corresponding to the capacitance is the two-dimensional value of an actual capacitance converted or not.

3. The multi-touch detecting method for touch screens according to claim 1 is characterized in that:
In Step B, the method to judge effective touch, namely “depression” existence in the whole area, is: judging whether groups in which some values are smaller than a touch threshold exist in the two-dimensional arrays obtained in Step A, wherein the area formed by these groups of values is a “depression” with low middle and rising circumference.

4. The multi-touch detecting method for touch screens according to claim 1 is characterized in that:
In Step E, the equivalent “depression” of the “depression” touched effectively includes all points of groups in which some values are smaller than a touch threshold, and the area formed by points on the lines connecting all the points.

5. The multi-touch detecting method for touch screens according to claim. 1 is characterized in that:
In Step F, the coordinate corresponding to the equivalent “depression” of the “depression” touched effectively is the central coordinate of the “depression”, and is calculated from the formula as follows:
$$\{ \begin{matrix}{X}_{M} = \frac{{\sum }_{i} ( {x}_{i} * Δ {C}_{i} )}{{\sum }_{i} Δ {C}_{i}} \\ {Y}_{M} = \frac{{\sum }_{i} ( {y}_{i} * Δ {C}_{i} )}{{\sum }_{i} Δ {C}_{i}} ,\end{matrix}$$
in which, i represents the No. of capacitance nodes in one “depression”; xᵢ and yᵢ respectively represent the abscissa/ordinate of the iₜₕ node; Cᵢ represents the corresponding capacitance of the iₜₕ node; and ΔCᵢ represents change in capacitance corresponding to the iₜₕ node.

6. The multi-touch detecting method for touch screens according to claim 1 is characterized in that:
In Step A, M*N two-dimensional values corresponding to the capacitances are formed by the difference between each capacitance and untouched “0” defined by a “capacitance difference image method”.

7. The multi-touch detecting method for touch screens according to claim 1 is characterized in that:
In Step A, M*N two-dimensional values corresponding to the capacitances are formed by filtering the difference between each capacitance and “0” through a first-order Butterworth filter.

8. The multi-touch detecting method for touch screens according to claim 1 is characterized in that:
In Step C, the concave degree coefficient
$$D = \frac{\sum Valley}{V}$$
of the “depression” touched effectively is smaller than a threshold, and the gradient distribution thereof conforms to the smooth gradient change in the “depression”, namely the gradient at the edge of the “depression” is less and then is increased gradually, and the gradient near the valley is decreased gradually; an area is formed by characteristic groups of values with gradient approximating “0” at the valley, in the formula, “V” represents the volume of the “depression” and is calculated from
$$V = {\sum }_{i} {C}_{i} ,$$
and “Valley” represents the sum of the values of the concave valley and circumference thereof.

9. The multi-touch detecting method for touch screens according to claim 1 is characterized in that:
The method also comprises Step D between Step C and Step E:
Compare and judge nodes at the edge of the “depression” touched effectively; If the change in capacitance of the nodes is smaller than a change threshold, multiply the change in capacitance by a coefficient which is greater than 0 and smaller than 1.

10. The multi-touch detecting method for touch screens according to claim 1 is characterized in that:
Conduct the smooth filtering of the central position in time for the equivalent “depression” of the “depression” touched effectively.
